(19) United States
(12) Patent Application Publication
(10) Pub. No.: US 2004/0114053 A1
(43) Pub. Date: Jun. 17, 2004

(54) SYSTEM AND METHOD FOR COLOR ENHANCING IMAGES

(75) Inventor: Barry Sandrew, Encinitas, CA (US)

Correspondence Address: DALINA LAW GROUP, P.C., 7910 IVANHOE AVE. #325, LA JOLLA, CA, 92037, US

(73) Assignee: LEGEND FILMS INC., San Diego, CA (US)

(21) Appl. No.: 10/605,001

(22) Filed: Aug. 29, 2003

(51) Int. Cl. H04N 9/74

(52) U.S. Cl. 348/582

(57) ABSTRACT

A system and method for color-correcting color images or movies or colorizing black and white images or movies is described. Images or movies are enhanced through application of multiple base color functions and multiple additive or subtractive alpha function weighted color functions that are injected into a selected region of an image using a pattern function. Images enhanced with embodiments of the invention are not limited to one-to-one mappings from input image luminance to output image color. All aforementioned functions may utilize underlying luminance, position or other parameters in enhancing colors.

### BACKGROUND OF INVENTION

1. Field of the Invention

Embodiments of the invention described herein pertain to the field of image analysis. More particularly, these embodiments enable color correction and enhancement of images.

2. Description of the Related Art

Existing methods of color image enhancement have relied upon automatic augmentation of a video signal, or have involved human controlled colorization of images. Inventions working on the video signal generally alter the chrominance portion of the signal without human intervention. These methods produce inferior results since the mapping of brightness values of an image to a hue requires human knowledge of what the hue of each object should be. For instance, with such methods, a human is required to subjectively intervene and make an educated guess as to the original hue of the region which is not possible by automated alteration of a video signal. Systems that are human controlled involve using single or multiple base colors per region of an input image to map one luminance value of the input region to one resulting output color, yielding a one-to-one mapping. Regardless of the number of colors utilized within a region, these inventions still produce a one-to-one mapping per pixel of luminance to color. The resulting images enhanced by these methods lack an element of realism since they somehow appear too homogenous with respect to the range of colors produced.

In terms of color nomenclature used herein, there are multiple theoretical models of color in existence. These include the Munsell color-order system otherwise known as ANSI standard Z138.2, the RGB system, the CMYK system, the CIE color models, the HLS system and many others. The RGB system is used in video monitors and is an additive system wherein red (R), green (G) and blue (B) mix together to form the color white. The CMYK system used in printing applications and is a subtractive system wherein cyan (C), magenta (M), and yellow (Y) mix to exclude colors and form a color close to black, so black (K) is also used in printing to make pure black. The CIE color models are influential in color measurement applications. The HLS or hue luminance saturation system is defined by a double conical volume, the bottom apex being black, the top apex being white, the height along the axis defining the luminance, the angle around the vertical axis defining the hue, and the distance from the axis defining the saturation. The HLS system is sometimes referred to as the HSL system, and has many closely related systems that are all more intuitive than picking RGB colors. Regardless of the theoretical model used, the transformation of one color to another color is a non-trivial process that involves the human eye, human mind, the electronic signal used in transmitting the image, the specific camera and film type used, the paper and ink that the image is printed on, and many other factors that are highly complex. Lightness, brightness and luminance have complex relationships that are well known.

In U.S. Pat. No. 4,984,072, entitled “System and method for color image enhancement”, a method of color enhancing regions in images having similar desired hues is described in which color lookup tables are used in order to convert gray-scale values into unique values of hue, luminance and saturation. This method yields a one-to-one mapping within a region for each gray-scale value as the color lookup table is “predetermined” by the mapping of a gray-scale value in a region to a hue, luminance and saturation value. There is no variation to this one-to-one mapping. There are no means in which to add or subtract multiple base colors or in which to randomize colors. There are no means described for randomizing the colors or opacities of colors injected in patterns into regions.

In U.S. Pat. No. 5,534,915, entitled “Method of color enhancing a monochrome image using multiple base colors for selected regions of the monochrome image”, a method is described in which multiple base colors are applied to a region of an image based on the brightness of each pixel in the region. This is accomplished by using a color lookup table that is constructed from multiple base colors defined for the input gray-scale value. Within that region, each gray-scale or luminance input value is mapped to one output color although different ranges of gray-scale can be mapped to entirely different colors. Therefore, there is still only a one-to-one mapping between gray-scale value in a region to a hue, luminance and saturation value. There are no means in which to utilize multiple base colors in any randomized or functional methodology. There are no means described for randomizing the colors or opacities of colors injected in patterns into regions.

### SUMMARY OF INVENTION

Embodiments of the invention color-correct color images or movies, and colorize black and white images or movies. This is accomplished by the transformation of an input pixel luminance to an output color in a one-to-many mapping valid for a region within the image. Regions are selected for their desired output color, and are generally recognizable objects which are a subset of the main image. There are many methods of defining regions and embodiments of the invention can use a region resulting from the application of any such method.

Colorizing an image or movie in a realistic manner comprises selecting base colors and injection colors for pattern based insertion into regions of each image. Embodiments of the invention allow base and injection colors to be selected via color functions that may return more than one result per input luminance value. Injection colors may be additive or subtractive in nature when combined with the base colors. In addition, the opacity of the injected colors may be selected via alpha functions that determine how opaque an injected color will appear over the base color. Alpha and opacity are used interchangeably herewithin. The injected colors are inserted into locations determined by a pattern function. This allows the resulting image to have regions which map luminance or gray-scale of a pixel to multiple colors in a one-to-many manner. These methods supply a broad palette of colors to the resulting image. The color, alpha and pattern functions may utilize luminance, position, or any other parameter in producing a return value.

Base colors differ from injection colors in that they are additive, otherwise one would simply choose the complement of the base color, and utilize a pattern that covers the entire region. Embodiments of the invention may set the base opacity to one minus the injection color opacity, while other embodiments use an alpha or opacity of one for the base color before mixing. The use of base colors allows colors to be easily added to a region without the need to specify the addition and subtraction setting, the opacity and without selecting a full area pattern. Other embodiments of the invention can bypass the use of base colors and allow the user to specify arithmetic mode, alpha and pattern for all colors, some of which may be set to use full area patterns as base colors would, and some of which may be set to use sparse patterns for injection into the base color of the region.

A color function is a function that yields at least one color comprising a given input luminance. Embodiments of the invention can use any algorithm or mathematical function to generate output colors. Colors can be returned from a point, line, curve, surface or volume of color space, using any color space model, or from any combination of these. The volume can be the entire color system space or a subset of the volume of the color space. The resulting output image created from a color function has a level of realism that exceeds prior art methodologies.

The injected colors can be added or subtracted from the base colors. Additive color math simply mixes the color with another color while subtractive color match mixes the complement of the color with another color.

An alpha function returns an alpha value, which is a measure of opacity for mixing. Any algorithm or mathematical function can be used in order to generate the resulting alpha value including but not limited to return of a constant value, random value or random value within or outside of a range.

A pattern function is any algorithm or mathematical function that can be used in order to generate an “inject” or “no-inject” assertion based on an input location within the region, or using any other parameter. This is used in order to spread the injected colors throughout the region and provides for color non-uniformities that exist in real world objects.

Since there is no one-to-one mapping between input luminance and output color the resulting image appears deeper in color and texture.

### BRIEF DESCRIPTION OF DRAWINGS

FIG. 1A is a view of a color function space with a point constant in hue and saturation at two luminance values along with a hue in HLS space that varies in saturation and is shown at two different luminance values with the luminance minimum value at the bottom of the figure and the luminance maximum at the top of the figure.

FIG. 1B is a view of the hue path projected onto the luminance equator as seen from the luminance apex.

FIG. 2A is a view of a color function space with varying hue with a fixed saturation level in HLS space and is shown at two different luminance values.

FIG. 2B is a view of the saturation path projected onto the luminance equator.

FIG. 3A is a view of a color function space with varying hue and varying saturation in HLS space and is shown at two different luminance values.

FIG. 3B is a view of the varying hue and varying saturation in HLS space projected onto the luminance equator.

FIG. 4 is a view of an injection color function space that varies in hue and saturation at two different luminance values processed with additive and subtractive function, alpha function, pattern function and a base color at the same two luminance values combined via a mixer function.

FIG. 5 is a view of two injection color function spaces which happen to overlap in the luminance axis showing four different luminance values processed with additive and subtractive function, alpha function, pattern function and a base color function space at the same four luminance values combined by a mixer function.

FIG. 6 is a view of the flow chart of user actions when working with an embodiment of the invention.

FIG. 7 is a view of the “Apply to Region” task of FIG. 6 which shows an embodiment of the task that is performed for an input luminance value for a given pixel location within a region of an image.

### DETAILED DESCRIPTION

Embodiments of the invention color-correct color images or movies, and colorize black and white images or movies. This is accomplished in at least one instance by the transformation of an input pixel luminance to an output color in a one-to-many mapping valid for a region within the image. Regions are selected for their desired output color, and are generally recognizable objects which are a subset of the main image. There are many methods of defining regions and embodiments of the invention can use a region resulting from the application of any such method.

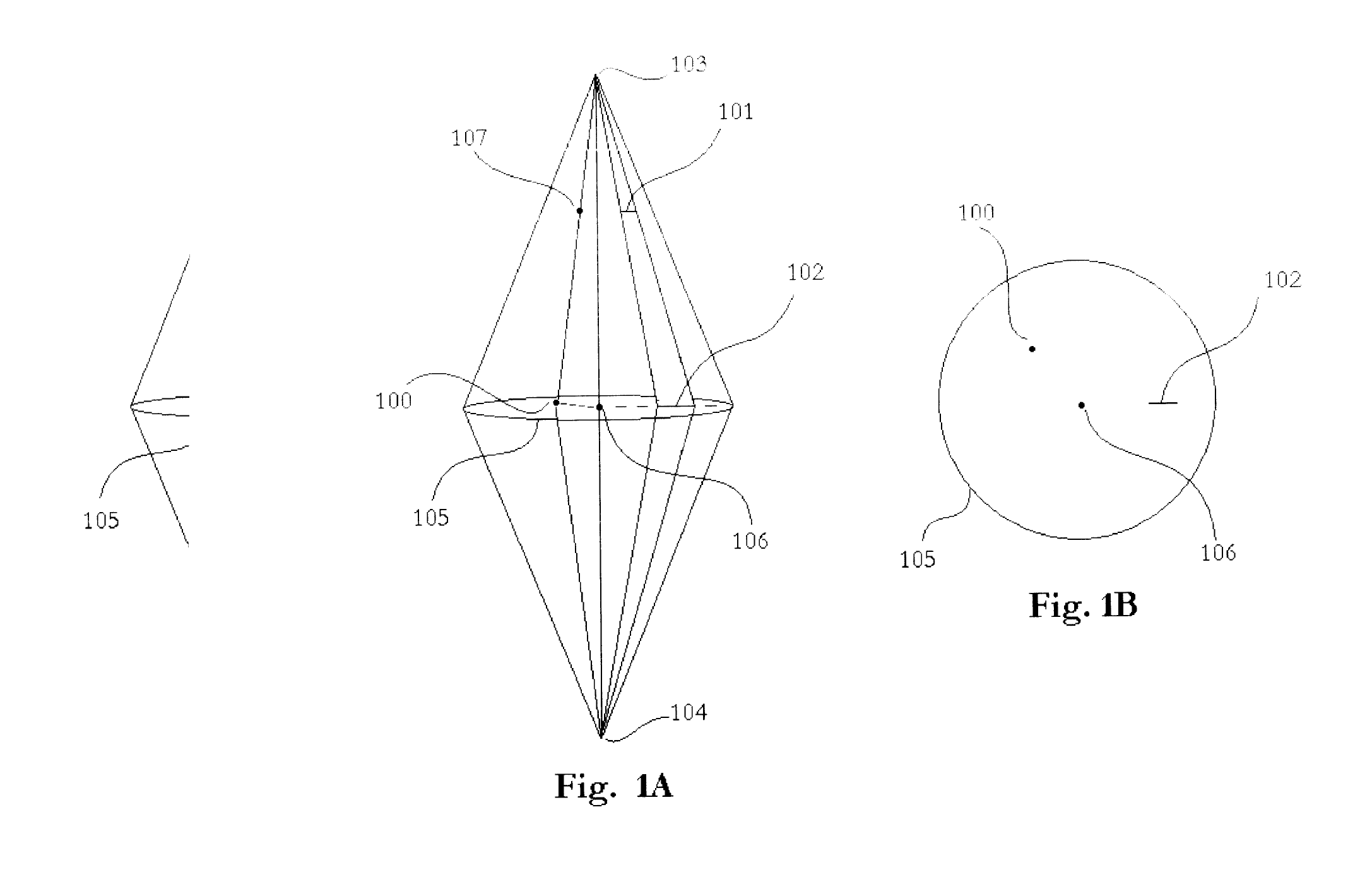

FIG. 1A is a view of a color function space using HLS space with luminance axis defined between points 104 and 103. Point 104 has luminance equal to zero, while point 103 has luminance equal to one. The hue varies around the axis and the ratio of the distance of a point off of the axis to the distance to the outside of the double cone at that luminance value is the saturation which therefore varies from 0 (zero) to 1 (one). Point 100 constant in hue, saturation at luminance value 0.5 and point 107 with same hue and saturation value at luminance value 0.8 in HLS space. Point 103 in HLS space has luminance value 1, while point 104 has luminance value 0, while point 106 has luminance value 0.5. Line 102 is constant in hue and varies in saturation and is shown at luminance value 0.5. Line 101 has the same range of saturation for the same hue as line 102, but at luminance value 0.8. FIG. 1B shows the luminance plane 105 at luminance value 0.5 with point 100 and line 102 as seen from point 103, hereinafter referred to as the top of HLS space. Point 107 projects onto point 100 and line 101 projects onto line 102. Points 100 and 107 differ in luminance only, and lines 101 and lines 102 differ in luminance only.

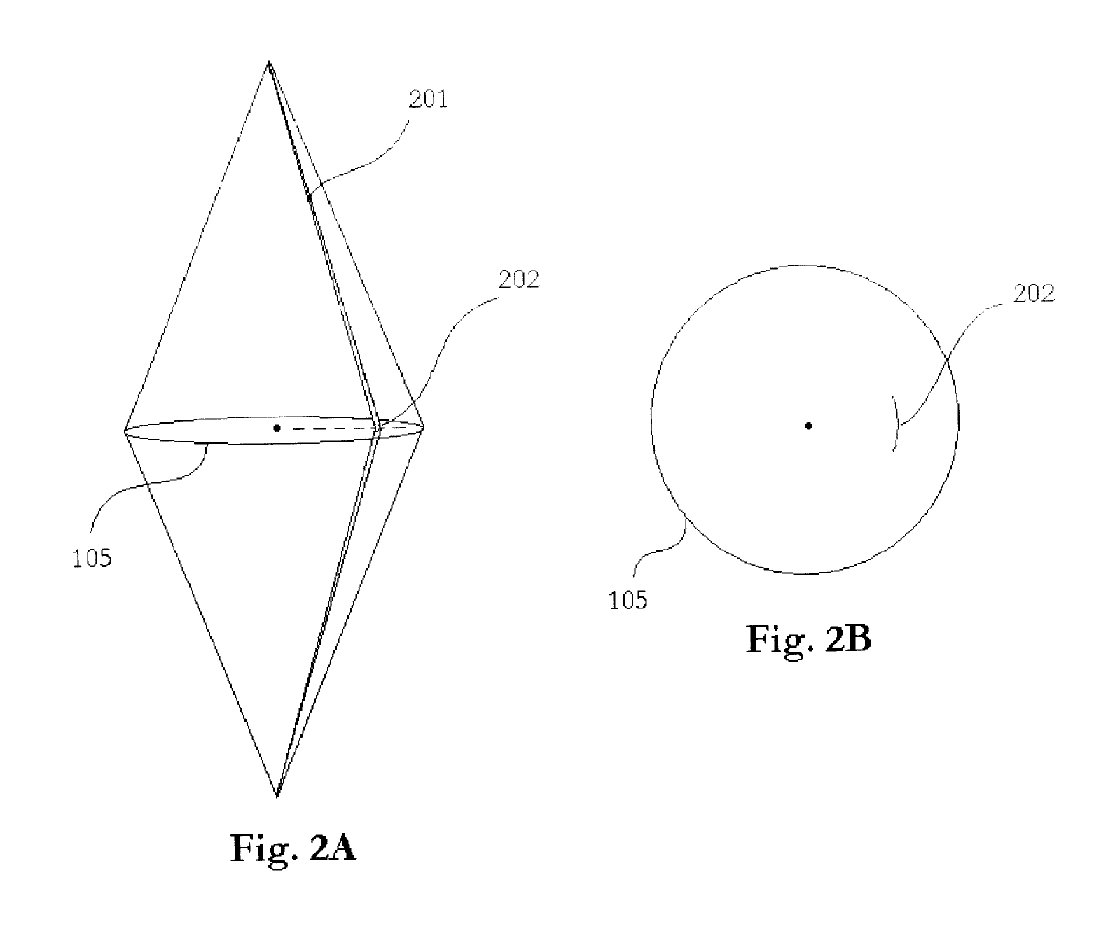

FIG. 2A is a view of color function space with a varying hue with a fixed saturation level in HLS space and is shown at two different luminance values. Curve 202 is constant in saturation and varies in hue and is shown at luminance value 0.5. Curve 201 has the same range of hue for the same saturation as curve 202, but with luminance value 0.8. FIG. 2B shows the luminance plane 105 at luminance value 0.5 with curve 202 as seen from the top of the HLS space. Curve 201 projects onto curve 202 and differ in luminance only.

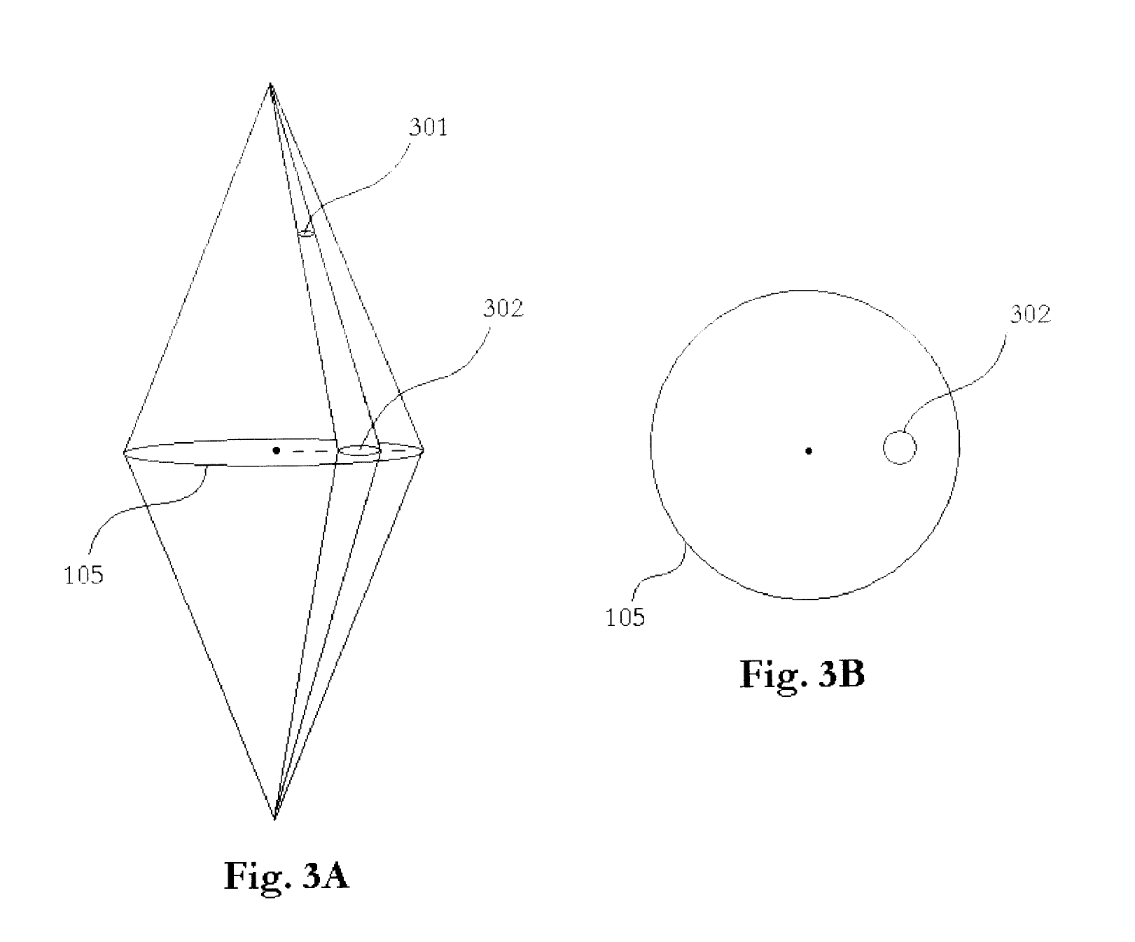

FIG. 3A is a view of a color function space with a varying hue and varying saturation in HLS space and is shown at two different luminance values. Area 302 varies in saturation and hue at luminance value 0.5. Area 301 has the same range of hue and saturation, but with luminance value 0.5. FIG. 3B shows the luminance plane 105 at luminance value 0.5 with area 302 as seen from the top of the HLS space. Area 301 projects onto area 302 and differ in luminance only.

Embodiments of the invention can use color functions that implement any algorithm or mathematical function to generate output colors including points as in FIG. 1A, lines in FIG. 1A, curves in FIG. 2A, areas in FIG. 3A, or any combination thereof. In addition, the various geometric shapes are not required to remain constant through the luminance range, meaning that completely separate hue and saturation shapes or ranges may exist in different luminance ranges. Although the area in FIG. 3A and 3B is shown appears as a circle, any geometric shape that varies in hue and saturation may be utilized. The use of HLS space is not a requirement and any color space may be utilized in specifying colors for use with different embodiments of the invention.

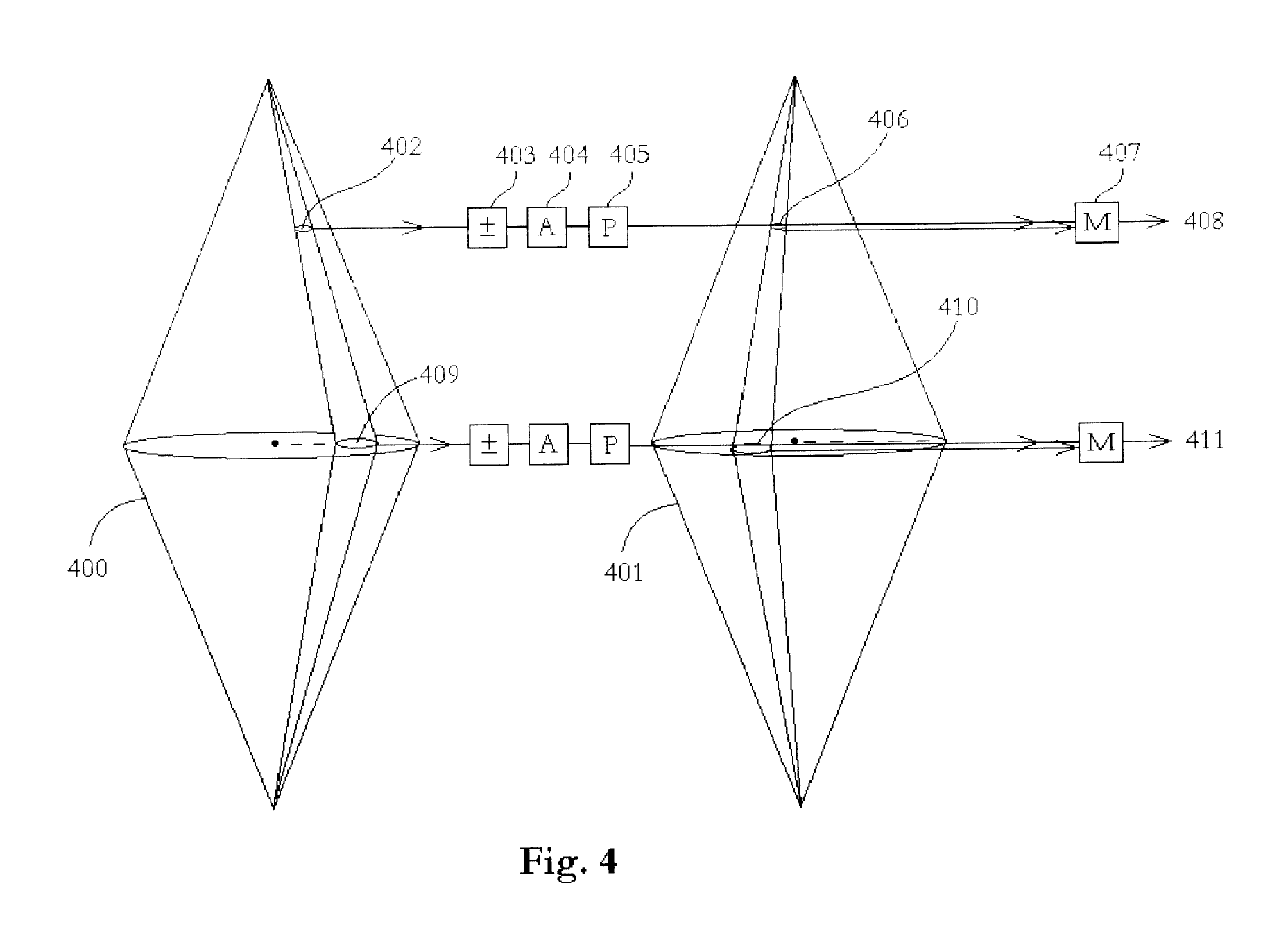

FIG. 4 is a view of injection color function space 400 defining area 402 that varies in hue and saturation at luminance value 0.8 processed with additive and subtractive function 403, alpha function 404, pattern function 405, and base area 406 in base color function space 401 at the same luminance value 0.8 combined via mixer function 407 to produce an output value. Injection area 409 and base area 410 are processed in the same manner as area 402 and 406 although at luminance value 0.5.

Multiple color spaces may be utilized for injection and base colors with each color space extending for part, or for the whole range, of input luminance values. This means that luminance ranges for different color functions may or may not overlap. Therefore, in addition to setting the color function luminance equator mapping to input luminance value, the upper and lower range of luminance values of a color function mapping may also be configured. This has the effect of shifting and scaling the resulting output luminance value for a given input luminance value when applying the color function.

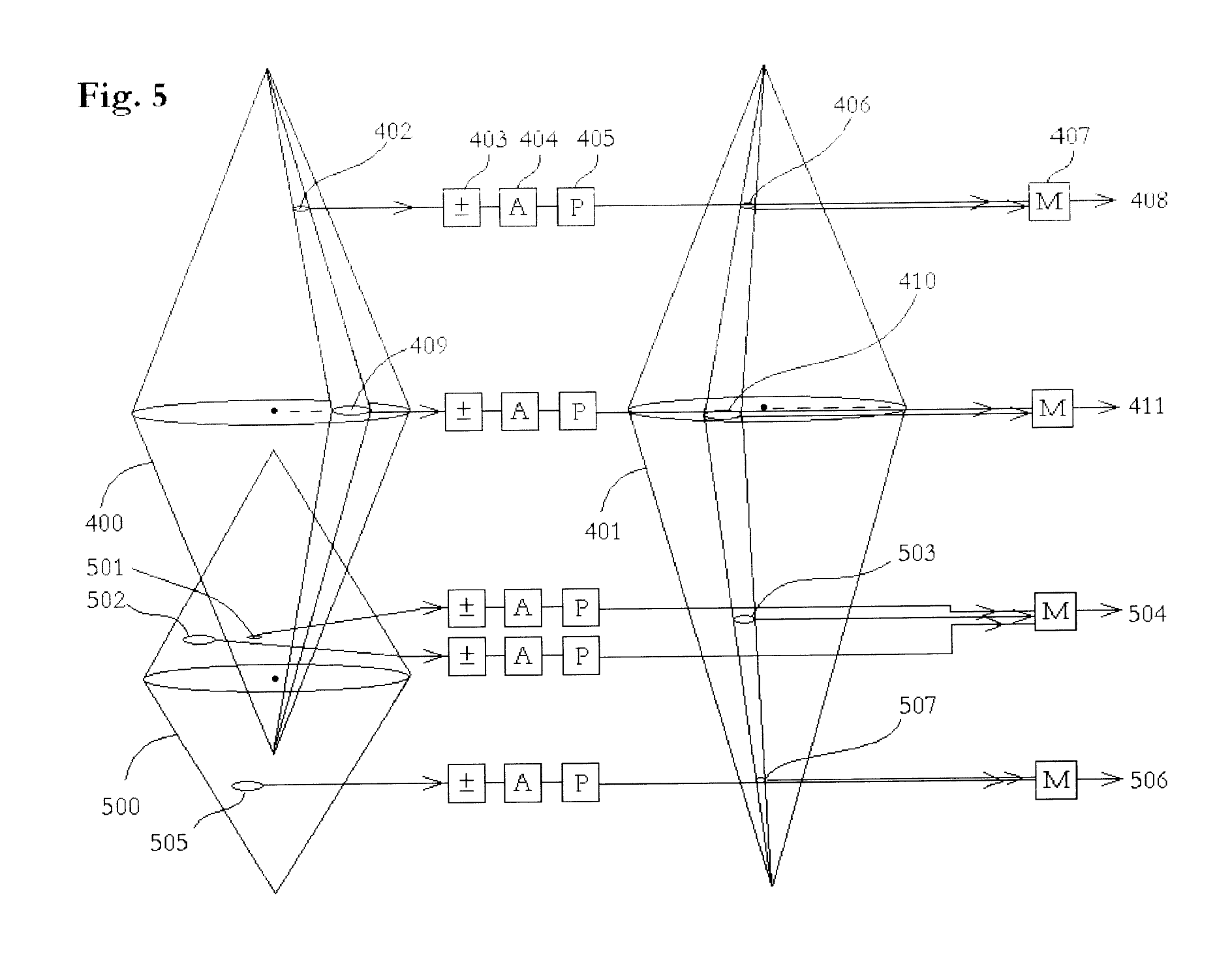

FIG. 5 is a view of two injection color spaces 400 and 500 showing the hue and saturation area 402 at luminance 0.85, area 409 at luminance value 0.6, areas 501 and 502 at luminance value 0.3 and area 505 at luminance value 0.15. Note that in this figure, the top of injection color space 400 has luminance value of 1, while the bottom of injection color space 500 has luminance value 0. The color functions yielding colors from areas 402, 409, 501, 502 and 505 have these resulting injection colors combined respectively with the areas in base color space 401, namely area 406 at luminance 0.85, area 410 at luminance value 0.6, area 503 at luminance value 0.3 and area 507 at luminance value 0.15. Multiple base color spaces can also be utilized, but only one is shown for simplicity of drawing. Although color space 400 and 500 are shown to overlap, they are not required to overlap. Area 501 is a second color area defined within color space 400, while area 502 is defined within color space 502. As area 402 and 409 represent the hue and saturation values that one color function may combine with the luminance value to generate colors, area 501 shows that more than one color function may be chosen for color space 400 and the range of luminance values assigned to it. Areas 501, 502 and 505 are shown without ray tracings to the top and bottom apex of their color space to represent functions that exist at only one luminance value. Area 501 and 502 at identical luminance value may or may not be both asserted at the same output pixel location based on assertions from their respective pattern functions.

Since areas 409, 410, 402, 406, 501, 502, 503, 505 and 507 can comprise any geometric size or shape, they may be points, lines, curves, or any other geometric shape or combination thereof, and may vary in form throughout the luminance range, and therefore may not project onto the same shape on the luminance equator as seen from the apex. An embodiment of the invention may utilize only points in color space type HLS, while another embodiment may utilize generalized volumes throughout any color space type including but not limited to HLS, RGB, the various CIE spaces, CYMK, or any variation of HLS including HSV, HSB, or any other color space type. Embodiments may use brightness, lightness or luminance as an input to the color functions and calculations of these quantities are well known in the art for different color space types.

For a given input luminance value, each injected color generation function returns a hue and saturation value pair that is either unaltered or complimented by additive and subtractive function 403. The alpha function 404 applied to the color determines how opaque the injected color is, and may be set by the operator of the system to any value between 0 and 1 or any function that generates values in this range including a random value or a value outside of a given range or any combination thereof. The resulting color with assigned alpha or opacity is applied to the region based upon the result of pattern function 405. Any pattern returning assertions that yield entirely empty and entirely full areas or anything in between may be used and selected by the operator. This includes random return of assertion based on the input location of the pixel undergoing processing, or repeating patterns such as true, true, false repeated over and over for each successively located pixel. Any function may be used including more complex functions that return polka dot shaped patterns, or any other pattern known including texture maps that repeat any number of times. Use of a texture map may comprise setting threshold values with luminance, position or any other parameter in order to determine whether to assert the injection or not based on the texture map values.

Base colors at luminance values that correspond to injection colors are combined by a mixer function 407. The application of additive and subtractive function 403, alpha function 404 and pattern function 405 occurs in no particular order, as different embodiments of the invention may apply a pattern function first in order to determine whether to generate a color before rendering its complement or opacity.

Although two injection color spaces are shown for simplicity, multiple color spaces for both injection color and multiple color spaces for base color may be utilized.

Although base color function space 401 shown in FIG. 4 is identical to base color function space 401 shown in FIG. 5, i.e. the same hue and saturation ranges are returned along the same paths such as area 406 and 410, each of the functions have been selected to map their values for different input ranges of luminance. In this case, the below average luminance colors map to more of the input luminance range so the base colors in this case are slightly darker than if the base color function space equator was equidistant between upper and lower apex as is the case in FIG. 4.

Associating a range of luminance values in which to map a color function space to can involve clipping a color function space, stretching the color function space, overlaying another space or use of any other mathematical function which can map an input luminance value to an output luminance value.

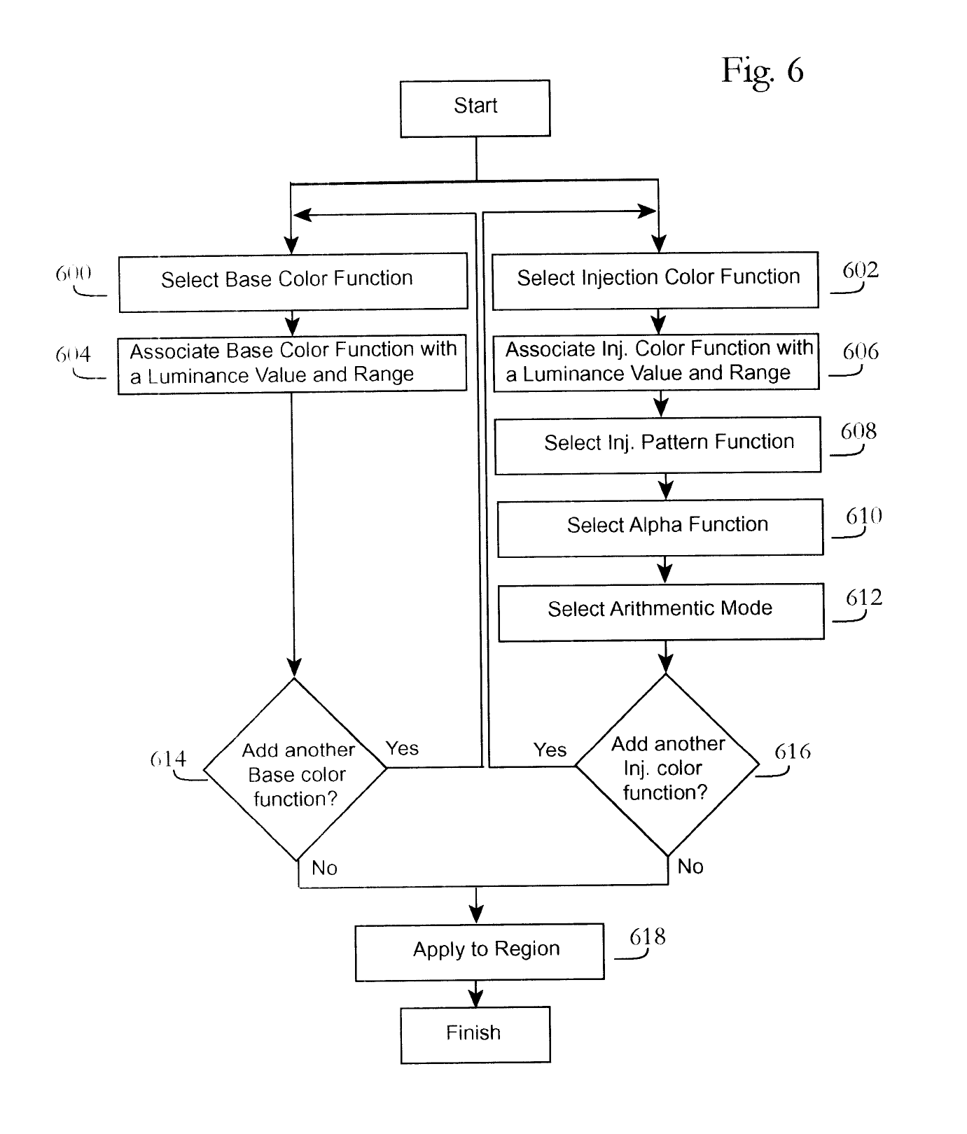

FIG. 6 shows a flow chart of actions that a user undertakes when working with an embodiment of the invention. The user selects base color (e.g., step 600) and/or injection color (e.g., step 602) functions to apply to a given region. The functions can be chosen from a list, drawn on a color wheel, chosen from a mathematical functions list, or via any other method. The color wheel may show the allowable hue and saturation values for the mapped value of input luminance for an embodiment of the invention utilizing the HLS color system. The base and injection color functions are independently associated with a range of input luminance values (e.g., steps 604 and 606 respectively). The injection pattern is selected (e.g., at step 608) from a list or by inputting a mathematical formula or by any other means. The alpha function is selected (e.g., at step 610) from a list or by inputting a mathematical formula or by any other means. At step 612, the arithmetic mode is selected for injection processing. Additional base and injection colors may be added at steps 614 and 616. The inputs selected are applied to the region (e.g., step 618). Other embodiments of the invention may show the effects of altering the settings after the user has input each one or during the time when the user is inputting or altering the settings. One skilled in the art would recognize that the order of these tasks may be altered in any way which produces the same result.

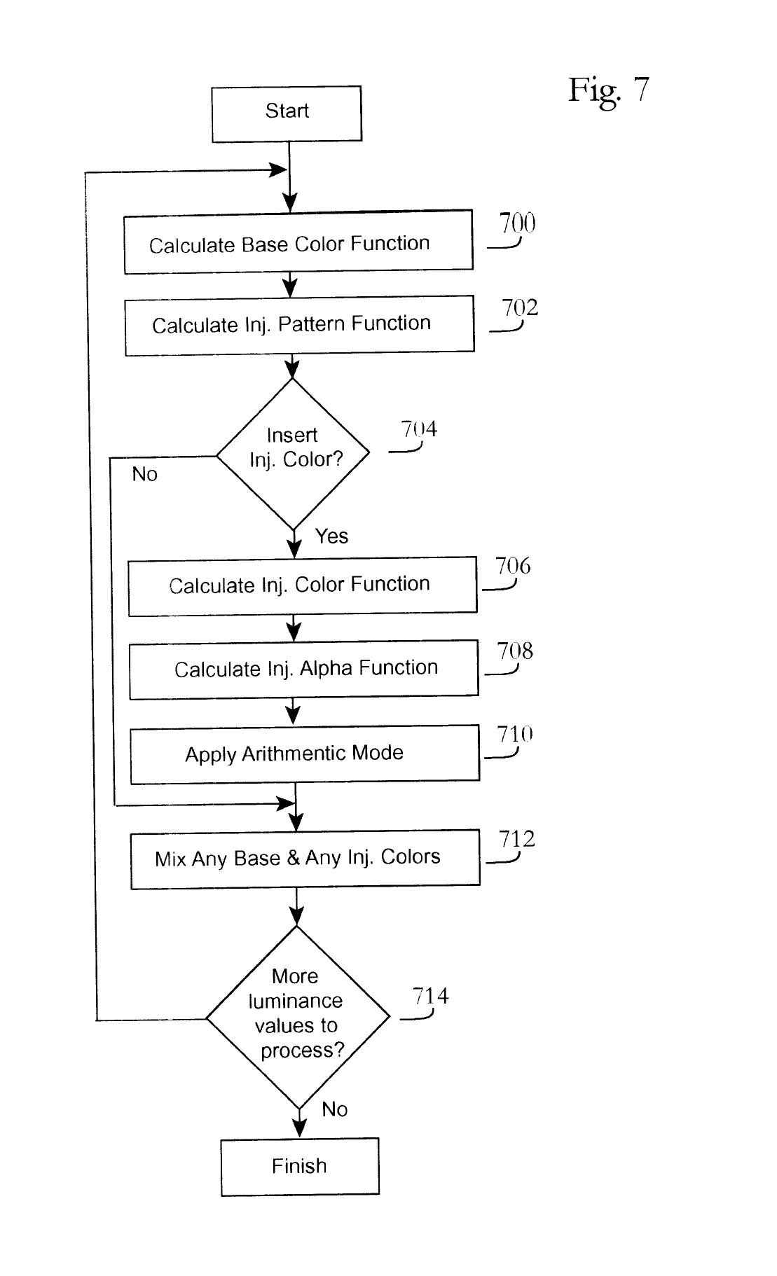

FIG. 7 shows a flow chart detailing the “Apply to Region” task of FIG. 6. A base color function is calculated (e.g., at step 700) for a given input luminance value for a given pixel location within a region of an image. This allows multiple values of color to result from one input luminance value. An injection pattern is calculated (e.g., at step 702) and if the function determines that an injection color should be asserted at a given location and luminance value (e.g. step 704) then the injection color function is calculated (e.g., step 706). The injection alpha function is calculated (e.g., at step 708) and the depending on the arithmetic mode, complemented or left unaltered (e.g., step 710). Any and all base and injection colors calculated are mixed (e.g., step 712). This process repeats based on the luminance value of every pixel in the region (e.g., step 714). One skilled in the art would recognize that the order of these tasks may be altered in any way which produces the same result. Thus, the sequence of the flowcharts described herein should not be viewed as being limited to any particular order of events.

Computer systems capable of processing the amount of data commonly found in a region or image are readily available and networked systems wherein each separate processor works on a portion of the image are also available and are capable of hosting embodiments of the invention.

What is claimed is:

1. In a computer system, a method of enhancing an image comprising:
selecting at least one base color function for a region of an image;
selecting at least one injection color function for said region;
associating a first luminance value and a first luminance range with said at least one base color function;
associating a second luminance value and a second luminance range with said at least one injection color function;
selecting at least one pattern function for said at least one injection color function; and,
applying said at least one injection color function using said at least one pattern function mixed with said at least one base color function to said region of said image for each luminance value within said region.

2. The method of claim 1 further comprising:
selecting an arithmetic mode for said at least one injection color function.

3. The method of claim 2 wherein said arithmetic mode is set to pass unaltered said at least one injection color function.

4. The method of claim 2 wherein said arithmetic mode is set to yield a color complement of said at least one injection color function at said second luminance value.

5. The method of claim 1 further comprising:
selecting an alpha function for said at least one injection color function.

6. The method of claim 5 wherein said alpha function returns a constant.

7. The method of claim 5 wherein said alpha function returns a random value within a range.

8. The method of claim 5 wherein said alpha function returns a random value outside a range.

9. The method of claim 1 wherein said pattern function returns an assertion for injection that is random.

10. The method of claim 1 wherein said pattern function returns an assertion for injection that repeats a pattern.

11. The method of claim 1 wherein said pattern function returns an assertion for injection that utilizes a texture map.

12. A system for enhancing an image comprising:
means for selecting at least one base color function for a region of an image;
means for selecting at least one injection color function for said region;
means for associating a first luminance value and a first luminance range with said at least one base color function;
means for associating a second luminance value and a second luminance range with said at least one injection color function;
means for selecting a pattern function for said at least one injection color function; and,
means for applying said at least one injection color function using said at least one pattern function mixed with said at least one base color function to said region of said image for each luminance value within said region.

13. The system of claim 12 further comprising:
means for selecting an arithmetic mode for said at least one injection color function.

14. The system of claim 12 further comprising:
means for selecting an alpha function for said at least one injection color function.
